(19) United States
(12) Patent Application Publication
(10) Pub. No.: US 2024/0164379 A1
(43) Pub. Date: May 23, 2024

(54) AGRICULTURAL COMPOSITION COMPRISING MELATONIN AND CARBOXYLIC COMPOUNDS FOR ENHANCING ANTIOXIDANT PROPERTY TO INCREASE CROP YIELD

(71) Applicant: FERTIS INDIA PVT. LTD., Hyderabad (IN)

(72) Inventors: Rahul Raju KANUMURU, Hyderabad (IN); George Kochumalayil SHAJI, Hyderabad (IN); Lakshmi Prasanna Kumar GARUDADRI, Hyderabad (IN); Ravikumar SURANENI, Hyderabad (IN); Sil ANINDYA, Hyderabad (IN)

(21) Appl. No.: 18/551,446

(22) PCT Filed: Mar. 22, 2022
(86) PCT No.: PCT/IN2022/050280

§ 371 Date: Sep. 20, 2023

(30) Foreign Application Priority Data
Mar. 22, 2021 (IN) 202141012166

(51) Int. Cl. A01N 43/38; A01N 25/30; A01N 37/02; A01N 37/06; A01N 37/40; A01N 43/12; A01P 21/00

(52) U.S. Cl. CPC A01N 43/38; A01N 25/30; A01N 37/02; A01N 37/06; A01N 37/40; A01N 43/12; A01P 21/00

(57) ABSTRACT

The present invention relates to an agricultural composition of melatonin and carboxylic compounds for improving the antioxidant property to combat environmental stresses. The present invention further relates to a process for improving the antioxidant property to combat environmental stress in the presence of the present agricultural composition.

### TECHNICAL FIELD OF THE INVENTION

The present invention relates to an agricultural composition of melatonin and carboxylic compounds for improving the antioxidant property to combat environmental stresses. The present invention further relates to a process for improving the antioxidant property to combat environmental stress in the presence of the present agricultural composition.

### BACKGROUND AND PRIOR ART OF THE INVENTION

Melatonin (N-acetyl-5-methoxytryptamine) is an indole-based structure which is classified as a potent, naturally occurring antioxidant and a signaling molecule based on its primary and secondarily-evolved functions in an organism. Melatonin plays an important role as a potential modulator on plant growth and development. Evidence has confirmed that a major portion of the melatonin is synthesized by plants themselves even though a homologue of the classic arylalkylamine N-acetyltransferase (AANAT) has not been identified as yet in plants.

Plant melatonin is involved in multiple physiological actions; including growth, rooting, seed germination, photosynthesis, osmoregulation, and protection against abiotic and biotic stressors. Plant melatonin not only acts as an antioxidant, but also induces substantial changes in gene expression in many physiological processes. Melatonin is a pleiotropic molecule with many diverse actions in plants. It is considered primarily an antioxidant with important actions in the control of reactive oxygen and nitrogen species (ROS and RNS), among other free radicals, and harmful oxidative molecules present in plant cells.

In addition, melatonin acts as an important signalling molecule to induce protective mechanisms via up-regulating the expression of defence genes by activating the salicylic acid (SA), gibberellic acid (GA) and ABA dependent pathways. There are also several studies that melatonin promotes seed germination, seedling growth, root regeneration, root growth and photosynthesis rate of horticultural crops under the influence of several environmental stresses.

Resistance to water logging stress of plants and eliminating ROS, alleviate oxidative damages on the plant caused by water logging stress and Biotic stresses with quality produce when compared with individual application of Melatonin and carboxylic compounds.
Marino B. Arnao et al. in a research study published in Plant Signaling & Behavior, 2007 titled “Melatonin in Plants” discloses that an exogenous application of melatonin helps in promoting lateral root regeneration, and growth in plants.
Janas, K. M et al. in a research study published in Acta Physiologiae Plantarum, 2013 titled “Melatonin, an underestimated natural substance with great potential for agricultural application” discloses that an exogenous application of melatonin helps in improving stresses tolerance in plants.
Jiang-Fei Meng et al. in a research study published in Food Science and Technology, 2019 titled “Melatonin treatment of pre-veraison grape berries modifies phenolic components and antioxidant activity of grapes and wine” discloses that an exogenous application of melatonin helps in improving the concentration of cyanin-3-O-glucoside, peonidin derivatives, and flavanols in grapes.

US Patent Publication No. 2020/0230059 discloses a solid micronized melatonin composition having a dry granulation including a melatonin powder, a carboxylic acid powder, and a powder of a hydrogel-forming polymer. The dry granulation is combined with pharmaceutical excipients in a dry orally ingestible pharmaceutical dosage form adapted to absorb water upon ingestion and form a hydrogel including soluble melatonin and soluble carboxylic acid in the hydrogel, the carboxylic acid being in an amount sufficient to impart a pH of 4.4 or less to the hydrogel after ingestion. However, the said composition is restricted to human consumption.

Based on the literatures pertaining to melatonin applications, there is a need in the art to provide a cost-effective and efficacious melatonin composition that will help in enhancing crop yield and quality by controlling oxidative stresses.

### OBJECT OF INVENTION

Accordingly, the main objective of the present invention is to provide an agricultural composition of melatonin and carboxylic compounds for improving the antioxidant property to combat environmental stresses.

Another object of the present invention is to provide a method for enhancing enzymatic reactions and metabolic pathways in plants in the presence of present agricultural composition.

### SUMMARY OF THE INVENTION

Accordingly, the present invention discloses an agricultural composition comprising melatonin and carboxylic compounds for improving the antioxidant property to combat environmental stresses.

In an embodiment of the present invention, the agricultural composition comprises melatonin in a concentration ranging from 1 gm/acre to 5 gm/acre and carboxylic compounds in a concentration ranging from 5 gm/acre to 100 gm/acre.

In another embodiment of the present invention, the carboxylic acids are selected from a group comprising formic acid, acetic acid, propionic acid, butyric acid, pelargonic acid, capric acid, stearic acid, lauric acid, palmitic acid, caprylic acid, adipic acid, fumaric acid, lactic acid, malic acid, phenyl lactic acid, succinic acid, tartaric acid, citric acid, ascorbic acid and their salts, benzoic acid, substituted benzoic acid and their salts, aromatic phenols and phenolic acids such as phenols, salicylic acids, gallic acids, and their salts, phenolic precursors (including but not limited to phenylalanine and/or capsaicin and/or valine, etc.), rosmarinic acid, caffeic acid, cinnamic acid, coumaric acid, ferulic acid, and their salts.

In still another embodiment of the present invention, the agricultural composition can be applied to plants in the form of powder, liquid, sprays, or injection in an appropriate amount.

In yet another embodiment of the present invention, the agricultural composition alleviates the effects of abiotic stresses on plant growth and yield.

In a preferred embodiment of the present invention, a method for enhancing enzymatic reactions and metabolic pathways involved in the production of melatonin in plants by using the present agricultural composition is further disclosed.

### BRIEF DESCRIPTION OF THE DRAWINGS

The invention has other advantages and features which will be more readily apparent from the following detailed description of the invention and the appended claims, when taken in conjunction with the accompanying drawings, in which:

FIG. 1: depicts the synergy of the agricultural composition with respect to protein content over melatonin applied alone compared with farmer practice in grain sample.

FIG. 2: depicts the synergy of the agricultural composition with respect to phenolic content over melatonin applied alone compared with farmer practice.

FIG. 3: depicts the enhanced melatonin activity of the agricultural composition in the presence of micronutrients in different plant species.

### DETAILED DESCRIPTION OF THE INVENTION

While the invention has been disclosed with reference to certain embodiments, it will be understood by those skilled in the art that various changes may be made and equivalents may be substituted without departing from the scope of the invention. In addition, many modifications may be made to adapt to a particular situation or material to the teachings of the invention without departing from its scope.

Throughout the specification and claims, the following terms take the meanings explicitly associated herein unless the context clearly dictates otherwise. The meaning of “a”, “an”, and “the” include plural references. The meaning of “in” includes “in” and “on.” Referring to the drawings, like numbers indicate like parts throughout the views. Additionally, a reference to the singular includes a reference to the plural unless otherwise stated or inconsistent with the disclosure herein.

The tables, figures and protocols have been represented where appropriate by conventional representations in the drawings, showing only those specific details that are pertinent to understanding the embodiments of the present invention so as not to obscure the disclosure with details that will be readily apparent to those of ordinary skill in the art having benefit of the description herein.

Accordingly, to accomplish the objectives of the present invention, the inventors propose an agricultural composition comprising melatonin and carboxylic compounds for improving the antioxidant property to combat environmental stresses.

In an embodiment of the present invention, the agricultural composition comprising melatonin and carboxylic acid plays a protective role against different abiotic stresses such as metal toxicity, temperature, drought, and salinity.

In another embodiment of the present invention, the carboxylic acids are selected from a group comprising formic acid, acetic acid, propionic acid, butyric acid, pelargonic acid, capric acid, stearic acid, lauric acid, palmitic acid, caprylic acid, adipic acid, fumaric acid, lactic acid, malic acid, phenyl lactic acid, succinic acid, tartaric acid, citric acid, ascorbic acid and their salts, benzoic acid, substituted benzoic acid and their salts, aromatic phenols and phenolic acids such as phenols, salicylic acids, gallic acids, and their salts, phenolic precursors (including but not limited to phenylalanine and/or capsaicin and/or valine, etc.), rosmarinic acid, caffeic acid, cinnamic acid, coumaric acid, ferulic acid, and their salts.

In still another embodiment of the present invention, the agricultural composition comprises melatonin in a concentration ranging from 1 gm/acre to 5 gm/acre and carboxylic compounds in a concentration ranging from 5 gm/acre to 100 gm/acre.

In another embodiment of the present invention, the agricultural composition optionally contains plant growth hormones selected from auxin, cytokinin, gibberellic acid, brassinosteroids, ethylene, abscisic acid, salicylic acid, and Jasmonic acid.

In still another embodiment of the present invention, the agricultural composition comprises plant growth hormones in a concentration ranging from 0.05% to 10%.

In an embodiment of the present invention, the agricultural composition further optionally comprises phenols, phenolic acids, phenolic salts, or combinations.

In another embodiment of the present invention, the phenolic compounds include but are not limited to phenols, polyphenols in form of all acids, phenolic salts, including but not limited to salicylates and/or benzoates and/or citrates and/or cinnamic acid and/or coumaric acid, etc., and/or phenolic precursors including but not limited to phenylalanine and/or capsaicin and/or valine, and/or phenol containing substances, etc.

In still another embodiment of the present invention, the agricultural composition comprises phenolic compounds in a concentration ranging from 0.05% to 25%.

In a preferred embodiment of the present invention, the agricultural composition comprises the melatonin and carboxylic acid with phenolic compounds is in the ratio of 1:55.

In an embodiment of the present invention, the agricultural composition optionally comprises adjuvants and or surfactants selected from anionic and non-ionic and cationic surfactants such as CMC, long-chain alcohols, lignosulfonates, etc. The addition of adjuvants ensures uniform and wide spreading of the composition on foliage when applied to maintain leaf and molecule contact.

In another embodiment of the present invention, the agricultural composition comprises adjuvant(s) and/or surfactant(s) in a concentration ranging from 5 gm/acre to 25 gm/acre.

In still another embodiment of the present invention, the agricultural composition can be applied to plants in the form of powder, liquid, sprays, or injection in an appropriate amount.

In an embodiment of the present invention, the agricultural composition enhances crop yields and decreases biotic or abiotic stress.

In another embodiment of the present invention, the agricultural composition enhances processes such as germination, growth, and rooting promoter and also as a foliar senescence retardant which were demonstrated, mainly in stress conditions.

In a preferred embodiment of the present invention, a method for enhancing enzymatic reactions and activating defensive and metabolic pathways by applying melatonin with a carboxylic compound in an amount of 0.5 ml to 3 ml/lit of the total composition is disclosed. The preferred mode of application is either by foliage or injecting into an appropriate plant part.

### EXAMPLES

The following examples, which include preferred embodiments, will serve to illustrate the practice of this invention, it being understood that the particulars shown are by way of example and for purpose of illustrative discussion of preferred embodiments of the invention.

Source: Melatonin and carboxylic acids used in the present invention have been synthetically produced or procured commercially.

### Example 1:—Composition Preparation

Composition consisting of melatonin and carboxylic acids (different micro-nutrients)

### General Procedure for Formulation of Said Composition:

Components mentioned in table 1, table 2, and table 3 were blended in a clean ss vessel and rotated at low rpm with 50 rpm to make a various homogeneous mixtures. The above mixtures were used as a foliar product for agriculture applications.

TABLE 1
Melatonin with Carboxylic acids

| S No | Component name | g/acre | g/acre | g/acre |
|---|---|---|---|---|
| 1 | Melatonin | 1.125 | 2.25 | 4.5 |
| 2 | Citric acid | 20 | 40 | 80 |
| 3 | salicylic acid | 6.9 | 13.8 | 27.6 |
| 4 | Ascorbic acid | 20 | 40 | 80 |
| 5 | Adjuvants | 5 | 10 | 20 |
| 6 | water soluble filler | 100 | 200 | 400 |
| | Total weight in g | 150 | 300 | 600 |

Composition consisting of melatonin and carboxylic acids along with optional components (phenol s/growth hormones)

TABLE 2

| S No | Component name | g/acre | g/acre | g/acre |
|---|---|---|---|---|
| 1 | Melatonin | 1.125 | 2.25 | 4.5 |
| 2 | Citric acid | 20 | 40 | 80 |
| 3 | salicylic acid | 6.9 | 13.8 | 27.6 |
| 4 | Ascorbic acid | 20 | 40 | 80 |
| 5 | Gibberellic acid | 1 | 2 | 4 |
| 6 | Abscisic acid | 0.5 | 1 | 2 |
| 7 | Adjuvants | 5 | 10 | 20 |
| 8 | Water soluble filler | 100 | 200 | 400 |
| | Total weight in g | 150 | 300 | 600 |

TABLE 3

| S No | Component name | g/acre | g/acre | g/acre |
|---|---|---|---|---|
| 1 | Melatonin | 1.125 | 2.25 | 4.5 |
| 2 | Gibberellic acid | 1 | 2 | 4 |
| 3 | Abscisic acid | 0.5 | 1 | 2 |
| 4 | Adjuvants | 5 | 10 | 20 |
| 5 | Water soluble filler | 2.5 | 5 | 20 |
| | Total weight in g | 10 | 20 | 50 |

### Example 2:—Parameter Analysis

Field trail on Paddy crop—After harvest—Grain samples analyzed the below parameters
1. % Of Protein
2. % Of Total phenol content
3. % Of micronutrients absorption
   Analysis of Protein Content Over Melatonin Applied Alone Compare with Farmer Practice

Total protein content in the sample content was estimated by performing Lowry method which include the following steps:—
1 g of samples in 25 ml was filtered through whatman filter paper 1.
4.5 ml of a reagent comprising NaOH, sodium potassium tartrate, and CuSO4·5H2O were added and incubated for 10 mins.
After incubation, 0.5 ml of Folin-Ciocalteu's phenol reagent were added and incubated for 30 mins.
Absorbance was measured with UV Vis Spectrophotometer at 660 nm and a standard graph was plotted.

### Result:

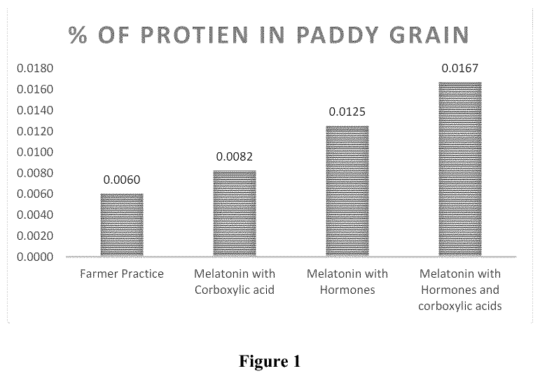

The amount of protein present in the given sample was found to be in a concentration ranging from 0.005-0.02%, further depicted in Table 4 and FIG. 1.

TABLE 4
% Of total protein in grain samples

| S. NO | Sample name | % of Protein |
|---|---|---|
| 1 | Farmer Practice | 0.0060 |
| 2 | Melatonin with Carboxylic acid | 0.0082 |
| 3 | Melatonin with Hormones | 0.0125 |
| 4 | Melatonin with Hormones and carboxylic acids | 0.0167 |

### Analysis of Total Phenol Content Over Melatonin Applied Alone Compare with Farmer Practice

Total phenol content was estimated by performing the following steps:—
10-15 ml of 70% MeOH (70 ml methanol: 30 ml water) were added to 1 g of test sample.
Filter through whatman filter paper 1 and was made up to 25 ml with 70% methanol.
5 ml of folin ciocalteu's phenol reagent were added.
Incubation for 5 mins.
4 ml of 7.5% Na2CO3 were added and incubated for 1 hr.
Absorbance was measured at 765 nm.

### Result:

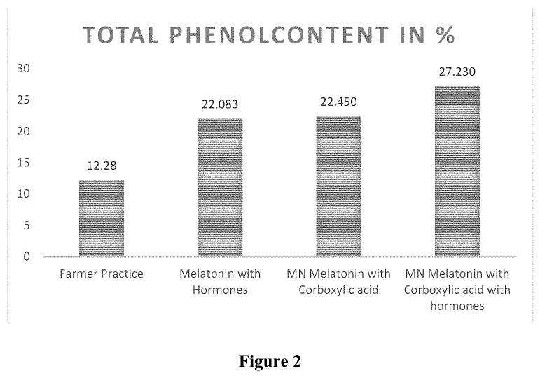

The amount of total phenol present in the given sample was found to be in a concentration ranging from 10-30 percentages disclosed in Table 5 and further depicted in FIG. 2.

TABLE 5

| S. | | Total Phenol |
|---|---|---|
| NO | Sample name | content in % |
| 1 | Farmer Practice | 12.28 |
| 2 | Melatonin with Hormones | 22.083 |
| 3 | MN Melatonin with Carboxylic acid | 22.450 |
| 4 | MN Melatonin with Carboxylic acid with hormones | 27.230 |

### Analysis of Micronutrient Absorption Levels in Paddy Grains

### Analysis of Micronutrients in Paddy Samples by ICP (Inductive Coupled Plasma) Equipment

The method includes the steps of:—
1. 1 gm of grain powder was added to 60 ml of perchloric acid and Nitric acid (9:1) and was digested overnight.
2. Heat the mixtures at 100 c for 2 hours until vapors change from red to white color.
3. The resultant solution was filtered through a Whatman paper and makeup to 100 ml with 1% nitric acid.
4. The solution was tested for micronutrients by ICP.

### Result:

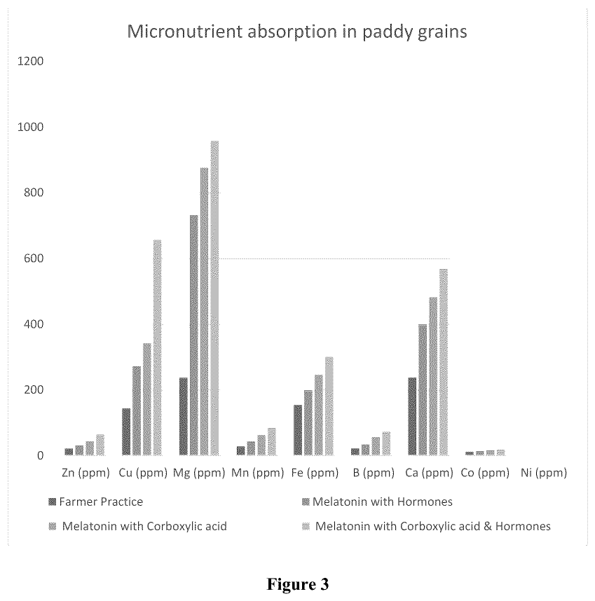

The amount of micronutrients present in the given paddy samples were found and disclosed in Table 6 and further depicted in FIG. 3.

TABLE 6

| | | Zn | Cu | Mg | Mn | Fe | B | Ca | Co | Ni |
|---|---|---|---|---|---|---|---|---|---|---|
| S. No | Sample name | (ppm) | (ppm) | (ppm) | (ppm) | (ppm) | (ppm) | (ppm) | (ppm) | (ppm) |
| 1 | Farmer Practice | 21.18 | 143.23 | 236.78 | 27.61 | 153.72 | 21.56 | 237.09 | 11.09 | 0.1 |
| 2 | Melatonin with | 31.3 | 272.0 | 732.0 | 43.3 | 198.0 | 34.2 | 398.0 | 14.0 | 0.4 |
| | Hormones | | | | | | | | | |
| 3 | Melatonin with | 43.7 | 342.5 | 876.49 | 62.86 | 245.87 | 56.98 | 481.93 | 16.75 | 0.5 |
| | Corboxylic acid | | | | | | | | | |
| 4 | Melatonin with | 65.2 | 657.32 | 958.73 | 85.39 | 301.29 | 73.2 | 568.93 | 18.96 | 0.7 |
| | Corboxylic acid | | | | | | | | | |
| | & Hormones | | | | | | | | | |

### Advantages of the Invention

1. A cost-effective and efficacious melatonin composition that helps in enhancing crop yield and crop quality by controlling oxidative stresses.
2. Helps in transporting ions to grains, tubers, fruits, and vegetables of a plant.
3. Contributes to crop production, total phenol content, total protein content, plant height, leaf area, reduction of stress symptoms, and nutrient composition.
4. Activates enzymes and metabolic pathways involved in the production of melatonin in plants.
5. Contribute in a providing protective role against different abiotic stresses such as metal toxicity, temperature, drought, and salinity.

1. An agricultural composition comprising melatonin in a concentration ranging from 1 gm/acre to 5 gm/acre; and carboxylic compounds in a concentration ranging from 5 gm/acre to 100 gm/acre; wherein the composition enhances crop yields and decreases biotic or abiotic stress.

2. The agricultural composition as claimed in claim 1, wherein the carboxylic acids are selected from a group comprising formic acid, acetic acid, propionic acid, butyric acid, pelargonic acid, capric acid, stearic acid, lauric acid, palmitic acid, caprylic acid, adipic acid, fumaric acid, lactic acid, malic acid, phenyl lactic acid, succinic acid, tartaric acid, citric acid, ascorbic acid and their salts, benzoic acid, substituted benzoic acid and their salts, aromatic phenols and phenolic acids such as phenols, salicylic acids, gallic acids, and their salts, phenolic precursors, rosmarinic acid, caffeic acid, cinnamic acid, coumaric acid, ferulic acid, and their salts.

3. The agricultural composition as claimed in claim 1, wherein the composition further comprises plant growth hormones, phenolic compounds, adjuvants, and surfactants.

4. The agricultural composition as claimed in claim 3, wherein the plant growth hormones are selected from a group comprising auxin, cytokinin, gibberellic acid, brassinosteroids, ethylene, abscisic acid, salicylic acid, and Jasmonic acid.

5. The agricultural composition as claimed in claim 4, wherein the plant growth hormones are in a concentration ranging from 0.05% to 10%.

6. The agricultural composition as claimed in claim 3, wherein the phenolic compounds are selected from a group comprising phenols, polyphenols, salicylates, benzoates, citrates, cinnamic acid, coumaric acid, phenylalanine, capsaicin, valine, and phenol containing substances.

7. The agricultural composition as claimed in claim 6, wherein the phenolic compounds are in a concentration ranging from 0.05% to 25%.

8. The agricultural composition as claimed in claim 3, wherein the melatonin and carboxylic acid with phenolic compounds are in a ratio of 1:55.

9. The agricultural composition as claimed in claim 3, wherein the adjuvants and/or surfactants are selected from anionic, non-ionic, and cationic surfactants.

10. The agricultural composition as claimed in claim 9, wherein the adjuvant(s) and/or surfactant(s) are in a concentration ranging from 5 gm/acre to 25 gm/acre.

11. The agricultural composition as claimed in claim 1, wherein the agricultural composition can be applied to the plants in the form of powder, liquid, sprays, gel, or injection in an appropriate amount.

12. The agricultural composition as claimed in claim 2, wherein the phenolic precursors include one or more of phenylalanine, capsaicin and valine.
